(19) United States
(12) Patent Application Publication
(10) Pub. No.: US 2024/0170862 A1
(43) Pub. Date: May 23, 2024

(54) Contact-Protected Screw-Connection Device

(71) Applicant: Bayerische Motoren Werke Aktiengesellschaft, Muenchen (DE)

(72) Inventor: Johannes DAHMER, Frick (CH)

(21) Appl. No.: 18/283,839

(22) PCT Filed: Apr. 21, 2022
(86) PCT No.: PCT/EP2022/060478

§ 371 Date: Sep. 25, 2023

(30) Foreign Application Priority Data
May 17, 2021 (DE) 10 2021 112 703.3

(51) Int. Cl. H01R 4/70; H01M 50/517; H01R 4/34

(52) U.S. Cl. CPC H01R 4/70; H01M 50/517; H01R 4/34

(57) ABSTRACT

A contact-protected screw-connection has a male screw connector and a female screw connector. The male screw connector has a connecting screw, which extends along a longitudinal axis in a screw direction towards the female screw connector and is screwed into a nut portion of the female screw connector. The connecting screw has a connecting-screw head, and the connecting screw extends along the longitudinal axis through a first electrical conductor. The connecting-screw head is arranged on a side of the first electrical conductor that is directed away from the nut portion. The male screw connector has a first protective cover, which encloses the connecting-screw head at a radial distance therefrom. The female screw connector has a second protective cover. The nut portion extends from a second electrical conductor, in the direction counter to the screw direction towards the first electrical conductor. The second protective cover encloses this region of the nut portion to some extent and at a radial distance therefrom. The nut portion extends from the second electrical conductor as far as a nut-end surface. The nut portion has a nut cap radially enclosing the nut portion to some extent and projecting beyond the nut portion to some extent. The male screw connector has a connecting sleeve that electrically conductively connects the first electrical conductor and the second electrical conductor and encloses the connecting screw at a radial distance therefrom and within the first protective cover. The connecting sleeve projects beyond the first protective cover to some extent in the screw direction.

### BACKGROUND AND SUMMARY

The invention relates to a contact-protected screw connection device.

U.S. Pat. No. 10,205,274 B2 discloses an electrical connecting apparatus.

In the following text, the invention is explained in conjunction with an electrical high voltage battery for a motor vehicle; this is not to be understood as a restriction of the invention to an application of this type. For electric or electrified vehicles, a high voltage storage device, in which individual energy storage cells are connected together to form the high voltage storage device, is provided for storing the energy to be provided for driving the vehicle. In order to connect the energy storage cells or modules of a plurality of energy storage cells to one another, electrical connectors are provided. The electrical connectors have a contact-protected interface which establishes an electrically conducting connection with high operational safety and simple assembly capability.

In certain applications, a female interface (socket) can be arranged on the side which faces the at least one energy storage cell, and the male region (plug) of this interface can be arranged on the other connector side, and it is thus made possible for sufficient safety to be achieved against unplanned contact of voltage-conducting components during assembly.

Against this background, it is an object of the invention to provide a contact-protected screw connection device, by way of which an electrically conducting connection can be established in a simple way. This object is achieved by way of a device according to the independent claims. Preferred developments of the invention are the subject matter of the dependent claims.

Within the context of the invention, a contact-protected screw connection device is understood to mean a device which is configured to establish an electrically conducting connection. Furthermore, destruction-free establishing and disconnecting again of this electrically conducting connection is made possible by means of this device. The proposed screw connection device has a male screw connector and a female screw connector. Here, the screw connection device is contact-protected in the assembled state, that is to say the voltage-conducting part of the screw connection device is covered by way of protective covers in such a way that contact of this, in particular by way of limbs, is prevented. Furthermore, in particular in relation to the requirements for electrical connections, reference is made to the IPXXB regulation according to DIN EN 60529.

The male screw connector has a connecting screw which extends along a longitudinal axis in a screwing direction toward the female screw connector. The connecting screw has a threaded bolt with a threaded portion, by means of which the connecting screw is screwed into a nut portion of the female screw connector. The connecting screw is received functionally into a first electrical conductor in such a way that, by means of it, in particular by means of a connecting screw head, a screwing force can be applied to the first electrical conductor, which screwing force is directed toward the second electrical conductor, and that the connecting screw is unscrewed from the nut portion in order to release the contact-protected screw connection device. In particular, the contact-protected screw connection device is configured to establish an electrically conducting connection between a first electrical conductor (male screw connector) and a second electrical conductor (female screw connector).

Furthermore, the connecting screw therefore has a connecting screw head, with which it preferably lies directly on the first electrical conductor, and this connecting screw further extends along the longitudinal axis through the first electrical conductor, in particular with a threaded bolt through a recess in the first electrical conductor. Furthermore, the connecting screw head is arranged on a side, facing away from the nut portion of the female screw connector, of the first electrical conductor, that is to say on what is known as the screw head side of the first electrical conductor.

Furthermore, a first protective cover is provided on the male screw connector, which first protective cover is configured for electrical insulation, in particular against undesired contact of voltage-conducting regions of the male screw connector. This first protective cover is preferably configured as a single-part or preferably multiple-part plastic cover. Furthermore, the first protective cover is configured in such a way that, spaced apart radially, it surrounds the connecting screw head, in relation to the longitudinal axis, at least in portions, or preferably completely. The first protective cover preferably makes contact with the connecting screw head, in particular the screw head cover. Furthermore, the male screw connector is configured in such a way that it does not provide complete contact protection by way of the first protective cover, in particular in the dismantled state (male screw connector completely released from the second screw connector). In particular, a simple and therefore inexpensive construction of the male screw connector is made possible by way of a configuration of this type.

The female screw connector is configured in such a way that it has a second protective cover. The second protective cover is preferably configured as a single-part or multiple-part cover. Furthermore, the nut portion is configured on this female screw connector. In particular, this nut portion extends at least in regions from the second electrical conductor in a direction counter to the screwing direction, what is known as the nut direction, and therefore toward the first electrical conductor. The second protective cover is further preferably configured in such a way that it surrounds at least that region of the nut portion which extends in the direction of the first electrical conductor, at least in portions and preferably completely. The second protective cover which is of electrically insulating configuration like the first protective cover preferably surrounds this nut portion spaced apart radially. The nut portion extends in the nut direction from the second electrical conductor as far as a nut end surface, and is therefore preferably configured as a region which is elevated with respect to a region, surrounding this directly, of the second electrical conductor. Furthermore, the nut portion has a nut cap which is of electrically insulating configuration. Furthermore, the nut cap surrounds the nut portion radially at least in portions or preferably completely. The nut cap further preferably protrudes at least in portions beyond the nut portion in the nut direction, that is to say in particular at individual locations, and the nut cap preferably protrudes beyond the nut portion in the nut direction completely. Furthermore, the nut cap has a nut cap recess, through which the connecting screw, in particular in the assembled state which is explained here of the contact-protected screw connection device, is screwed into the nut portion. The second protective cover and the nut cap further preferably protrude in the nut direction in front of the voltage-conducting components of the female screw connector, with the result that a contact protection means is formed by them which, in particular, prevents unplanned contact of these components by limbs.

Furthermore, it is proposed that the male screw connector has a connecting sleeve which is preferably held on the first screw connector in a positively locking manner, preferably by means of the first protective cover. Furthermore, this connecting sleeve is configured in such a way that it forms a first current conducting path between the first and the second electrical conductor, with the result that this first current conducting path connects the first electrical conductor and the second electrical conductor to one another in an electrically conducting manner in the assembled state of the contact-protected screw connection device. The connecting sleeve is geometrically configured in such a way that it surrounds the connecting screw at least in portions and is accordingly spaced apart radially from the latter. Furthermore, the connecting sleeve is arranged in the radial direction, that is to say orthogonally with respect to the longitudinal axis, within the first protective cover. In the screwing direction, the connecting sleeve is configured in such a way that it, in particular in the assembled state of the contact-protected screw connection device, protrudes beyond the first protective cover at least in portions or completely, with the result that, figuratively speaking, the connecting sleeve protrudes out of the first protective cover in the screwing direction.

High safety, in particular satisfactory contact protection, can be achieved, in particular, by means of a configuration of this type of a contact-protected screw connection device. The contact protection can be achieved in a sufficient form insofar as only the female screw connector is connected to a voltage source (a voltage source of this type can be a battery device) and the male screw connector is connected to an electrically passive component such as, in particular, an electronic power system. Furthermore, a simple connectivity of the two screw connectors to the proposed contact-protected screw connection device is then made possible, in particular as a result of the omission of the special contact protection means on the male screw connector.

In one preferred embodiment, the connecting screw head has a screw head cover. The screw head cover preferably covers the connecting screw head at least in portions or preferably completely; the connecting screw head is further preferably not covered by the screw head cover in the region in which it makes contact with the first electrical conductor. The first protective cover further preferably has a screw head recess, with the result that the connecting screw head is accessible from outside the contact-protected screw connection device, in particular is accessible by means of a screwdriver for applying a tightening torque. The screw head cover has, as a constituent part, an electrically insulating material, or consists of the latter. The screw head cover is preferably connected in a positively locking or integrally joined or positively locking/integrally joined manner to the connecting screw. The first electrical conductor or the connecting screw head is further preferably covered on the screw head side, at least in the region of the first protective cover, by means of this first protective cover and by means of the screw head cover, in such a way that unplanned contact of voltage-conducting components is prevented in this region.

In one preferred embodiment, the screw head cover has a screw head profile for applying a torque to the connecting screw head of the connecting screw. In order to apply the torque to the connecting screw head, the screw head cover is preferably connected fixedly to the connecting screw head for conjoint rotation. Therefore, screwing in of the connecting screw is preferably made possible, preferably by means of a screwdriver, this screwdriver in the process making contact with the screw head cover in order to apply the tightening torque. Furthermore, the screw head cover is profiled in order to apply a tightening torque, preferably on an outer circumferential surface. In particular, particularly satisfactory contact protection can be achieved by means of an embodiment of this type of the invention.

In one preferred embodiment of the invention, the connecting sleeve is configured as a separate component with respect to the first electrical conductor. The connecting sleeve is further preferably received loosely with respect to the first electrical conductor, preferably by means of the first protective cover. The first protective cover further preferably has a connecting sleeve recess. The connecting sleeve preferably protrudes in the screwing direction out of the first protective cover; the connecting sleeve is further preferably covered by the first protective cover at least in portions, in particular in the longitudinal direction and therefore only in portions. The connecting sleeve further preferably has a connecting sleeve collar. The connecting sleeve collar is preferably configured as a collar which runs radially around the longitudinal axis, at least in portions or preferably completely. With the first protective cover, the connecting sleeve collar further preferably forms a captive securing means for the first connecting sleeve, with the result that the latter cannot be removed in an unplanned manner from the first protective cover. The connecting sleeve is further preferably received in the first protective cover such that it can be moved in the direction of the longitudinal axis with respect to the first electrical conductor in an unmounted state of the contact-protected screw connection device (male screw connector removed from female screw connector). A simple assembly capability of the male screw connector with respect to the female screw connector is made possible, in particular, by means of an embodiment of this type of the contact-protected screw connection device.

In one preferred embodiment of the invention, the nut portion, into which the connecting screw is screwed, is configured in a nut sleeve. The nut sleeve is further preferably configured as a separate component with respect to the second electrical conductor, and is further preferably connected to the latter in an electrically conducting manner. In order to configure this (preferably, electrically conducting) connection, the nut sleeve is further preferably connected in a positively locking or integrally joined manner to the second electrical conductor. The nut sleeve is further preferably configured from a different type of material than the second electrical conductor. The material selection which is fit for purpose is made possible, in particular, in the case of different materials. The nut sleeve is further preferably configured from an identical material to the second electrical conductor. A simple connectivity of the nut sleeve to the second electrical conductor is made possible, in particular, in the case of identical materials. The nut sleeve is preferably configured in one piece with the second electrical conductor.

In one preferred embodiment, the connecting sleeve has a first axial end surface. This first axial end surface is preferably oriented orthogonally with respect to the longitudinal axis. The connecting sleeve further preferably has a second end surface which is preferably oriented parallel to this first end surface. The second axial end surface is preferably spaced apart axially from the first axial end surface in the direction of the longitudinal axis, and the connecting sleeve further preferably extends (at least substantially) in the axial direction between these two end surfaces. The first axial end surface is preferably configured to make contact with the first electrical conductor, and the second axial end surface is further preferably configured to make contact with the second electrical conductor. In the assembled state of the contact-protected screw connection device, the connecting sleeve makes contact by way of the first end surface with the first electrical conductor and by way of the second axial end surface with the second electrical conductor. A first electrical current conducting path is preferably configured from the first electrical conductor via the connecting sleeve to the second electrical conductor, and a second electrical current conducting path is further preferably formed, in addition to this first current conducting path, by means of the connecting screw from the first electrical conductor via the connecting screw to the nut sleeve and therefore to the second electrical conductor. A high current carrying capacity can be achieved, in particular, by means of an embodiment of this type of the invention.

In the following text, individual features and preferred developments of the invention will be explained in greater detail on the basis of the figures.

### BRIEF DESCRIPTION OF THE DRAWINGS

FIG. 1 is a partial cross-sectional view of a contact-protected screw connection device;

FIG. 2 is a partial cross-sectional view of the contact-protected screw connection device, but only of the current-conducting components;

FIG. 3 is a sectional illustration of the female screw connector;

FIG. 3a is a sectional illustration of the connecting sleeve;

FIG. 4 is a sectional illustration of the female screw connector; and

FIG. 5 is a sectional illustration of a connection system with a connecting element.

### DETAILED DESCRIPTION OF THE DRAWINGS

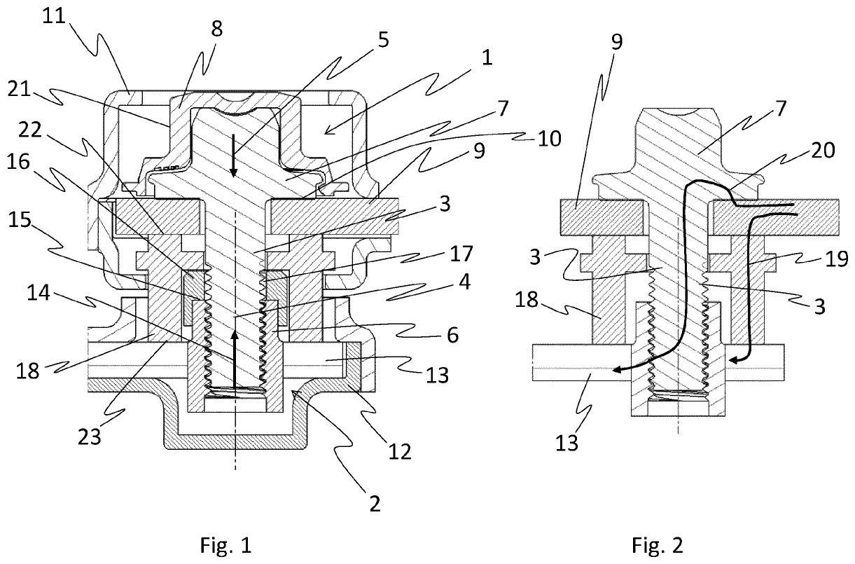

FIG. 1 shows a contact-protected screw connection device in a sectional illustration. The illustrated screw connection device has a male screw connector 1 and a female screw connector 2. The male screw connector 1 has a connecting screw 3 which extends along a longitudinal axis 4 in a screwing direction 5 toward the female screw connector 2. The connecting screw 3 is screwed into the nut portion 6 (this is configured as a nut sleeve and is connected in an integrally joined manner to the second electrical conductor 13) of the female screw connector 2. The connecting screw 3 has a connecting screw head 7 and extends along the longitudinal axis 4 through the first electrical conductor 9. The connecting screw head 7 is arranged here on a side, facing away from the nut portion 6, of the first electrical conductor 7, what is known as the screw head side 10.

The male screw connector 1 has a first protective cover 11 which surrounds the connecting screw head 7 spaced apart radially at least in portions, in relation to the longitudinal axis 4. The female screw connector 2 has a second protective cover 12, the nut portion 6 extending at least in regions from the second electrical conductor 13 in the direction counter to the screwing direction 5, what is known as a nut direction 14, toward the first electrical conductor 9, and the second protective cover 12 surrounding this region of the nut portion 6 at least in portions and spaced apart radially from the latter. The nut portion 6 extends in the nut direction 13 from the second electrical conductor 14 as far as a nut end surface 15, the nut portion 6 having a nut cap 16, the nut cap 16 surrounding the nut portion 6 radially at least in portions and protruding at least in portions beyond the nut portion 6 in the nut direction 14, that is to say projecting beyond it in the nut direction 14. Furthermore, the nut cap 6 has a nut cap recess 17, through which the connecting screw 3 is screwed into the nut portion 6 and thus configures a screw connection, by way of which the first electrical conductor 9 can be braced against the second electrical conductor 13.

The male screw connector 1 has a connecting sleeve 18. The connecting sleeve 18 connects the first and the second electrical conductors 9, 13 in an electrically conducting manner. Furthermore, the connecting sleeve 18 surrounds the connecting screw 3 in the direction of the longitudinal axis partially, and is spaced apart radially from the latter. Furthermore, the connecting sleeve 18 is received partially in the first protective cover 11 and is thus surrounded partially by the latter. Furthermore, the connecting sleeve 18 is received in the first protective cover 11 in such a way that the connecting sleeve 18 protrudes beyond the first protective cover 11 in the screwing direction 5. Furthermore, the connecting sleeve 18 is configured in such a way that it makes contact both with the first electrical conductor 9 and with the second electrical conductor 13, and these two electrical conductors 9, 13 are braced against one another, furthermore, by way of the connecting screw 3 which is screwed into the nut portion 6 which is connected fixedly to the second electrical conductor 13, and contacting with low contact resistances is thus achieved from the first electrical conductor 9 to the connecting sleeve 18, and from the connecting sleeve 18 to the second electrical conductor 13.

Both the screw head cover 8, the first protective cover 11 and the second protective cover 12 have an electrically insulating plastic as constituent part. The first and the second protective cover 11, 12 are configured in multiple pieces, in particular in order to achieve a simple assembly capability.

FIG. 2 shows a sectional illustration of the electrically voltage-conducting components of the device which is shown in FIG. 1. An essential object of the proposed invention is establishing an electrically conducting connection from the first electrical conductor 9 to the second electrical conductor 13. Two current conducting paths 19, 20 are configured between the two electrical conductors 9, 13. Firstly, electrical current is transmitted from the first electrical conductor 9 via the connecting sleeve 18 to the second electrical conductor 13 (first current conducting path 19), and secondly from the first electrical conductor 9 via the connecting screw 3 to the second electrical conductor 13 (second current conducting path 20).

The first electrical conductor 9 is braced via the connecting sleeve 18 to the second electrical conductor 13 by way of tightening of the connecting screw 3, via its connecting screw head 7.

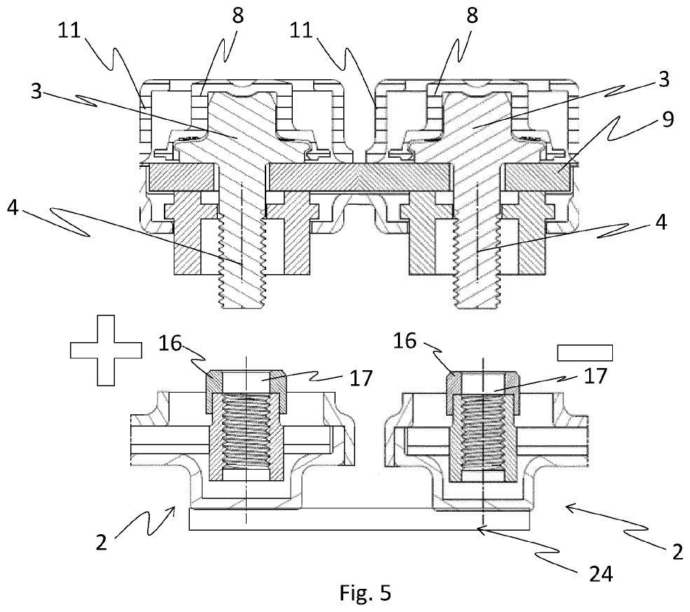

Furthermore, contact of a potential can be ruled out at any time as a result of the mechanical connection of the positive (+) and the negative pole (−) with respect to one another according to FIG. 5. This additional, optional measure can achieve a system which protects against electric shock even in the event of a first fault.

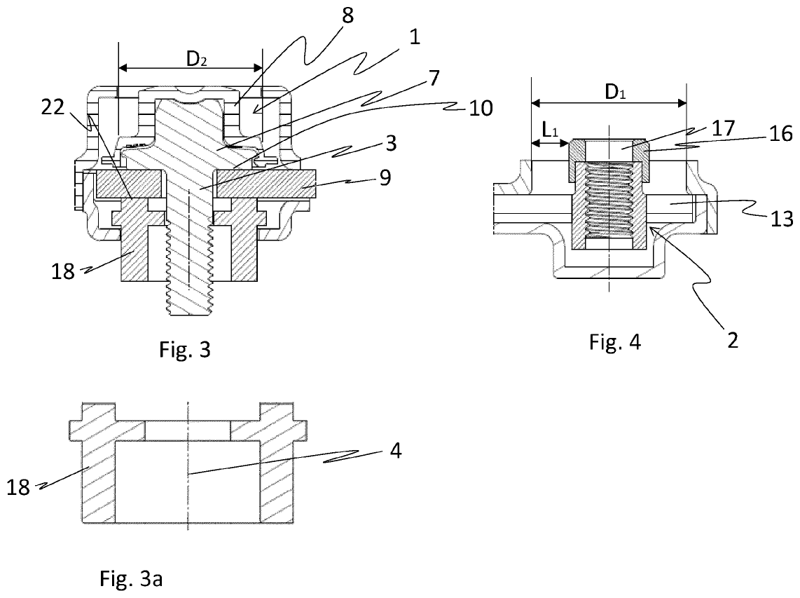

In the case of one embodiment, in which, according to FIG. 3, the diameter D₂ is smaller than or equal to 12 mm, a screw head cover 8 can be dispensed with, since, in particular, sufficient contact protection can be achieved in a case of this type, in particular by means of the first protective cover. In the case of embodiments of the female screw connector 2, which is shown in greater detail in FIG. 4, in which the diameter D₂ is less than or equal to 12 mm, the nut cover 16 can be dispensed with. Furthermore, it is preferably proposed that the spacing L₁ is less than or equal to 6 mm, preferably less than or equal to 4 mm and with preference less than or equal to 2 mm. The spacing L₁ results, in particular, between the nut portion 6 or the nut end cap 16 and the insulation which surrounds the nut portion 6 and is a constituent part of the second protective cover 12. FIG. 3a shows a more detailed illustration of the connecting sleeve 18.

### LIST OF DESIGNATIONS

1 Male screw connector
2 Female screw connector
3 Connecting screw
4 Longitudinal axis
5. Screwing direction
6 Nut portion
7 Connecting screw head
8 Screw head cover
9 First electrical conductor
10 Screw head side
11 First protective cover
12 Second protective cover
13 Second electrical conductor
14 Nut direction
15 Nut end surface
16 Nut cap
17 Nut cap recess
18 Connecting sleeve
19 First current conducting path
20 Second current conducting path
21 Profiled surface
22 First axial end surface of 18
23 Second axial end surface of 18
24 Connecting element
D₂ Diameter at the male screw connector
D₁ Diameter at the female screw connector
+ Positive pole
− Negative pole

1.-6. (canceled)

7. A contact-protected screw connection, comprising:
a male screw connector;
a female screw connector,
wherein the male screw connector has a connecting screw which extends along a longitudinal axis in a screwing direction toward the female screw connector, and is screwed into a nut portion of the female screw connector, the connecting screw having a connecting screw head;
a first electrical conductor through which the connecting screw extends along the longitudinal axis, the connecting screw head being arranged on a screw head side, facing away from the nut portion, of the first electric conductor;
a first protective cover for the male screw connector, which cover, in relation to the longitudinal axis, surrounds the connecting screw head spaced apart radially at least in portions;
a second protective cover for the female screw connector;
a second electrical conductor from which the nut portion extends at least in regions in a nut direction counter to the screwing direction toward the first electrical conductor,
wherein the second protective cover surrounds this region of the nut portion at least in portions and spaced apart radially from the latter,
wherein the nut portion extends in the nut direction from the second electrical conductor as far as a nut end surface,
wherein the nut portion has a nut cap, the nut cap surrounding the nut portion radially at least in portions, and protruding at least in portions beyond the nut portion in the nut direction, and the nut cap further having a nut cap recess, through which the connecting screw is screwed into the nut portion; and
a connecting sleeve of the male screw connector, which connecting sleeve connects the first and the second electrical conductors in an electrically conducting manner and surrounds the connecting screw spaced apart radially and within the first protective cover,
wherein the connecting sleeve protrudes at least in portions beyond the first protective cover in the screwing direction.

8. The contact-protected screw connection device according to claim 7, wherein
the connecting screw head is covered at least in portions by a screw head cover.

9. The contact-protected screw connection device according to claim 8, wherein
the screw head cover has a screw head profile for applying a torque to the screw head of the connecting screw.

10. The contact-protected screw connection device according to claim 7, wherein
the connecting sleeve is configured as a separate component with respect to the first electrical conductor.

11. The contact-protected screw connection device according to claim 7, wherein
the nut portion is configured in a nut sleeve, and
the nut sleeve is connected in a positively locking or integrally joined manner to the second electrical conductor.

12. The contact-protected screw connection device according to claim 7, wherein
the connecting sleeve has a first axial end surface which is oriented orthogonally with respect to the longitudinal axis, and a second axial end surface which is spaced apart axially from and is parallel to the first axial end surface,
the first axial end surface makes contact with the first electrical conductor, and
the second axial end surface makes contact with the second electrical conductor.
